(19) United States
(12) Patent Application Publication
(10) Pub. No.: US 2015/0338164 A1
(43) Pub. Date: Nov. 26, 2015

(54) Genetic Profiling Flexible Microplate Drying Systems and Methods

(71) Applicant: PIONEER HI BRED INTERNATIONAL INC, Johnston, IA (US)

(72) Inventors: Kevin Day, BOONE, IA (US); Brian Hutzel, GRIMES, IA (US); Caleb Joens, BOONE, IA (US); Christopher Reppe, WAUKEE, IA (US)

(73) Assignee: PIONEER HI BRED INTERNATIONAL INC, Johnston, IA (US)

(21) Appl. No.: 14/285,783

(22) Filed: May 23, 2014

(51) Int. Cl. F26B 13/14; F26B 5/00; F26B 13/24

(52) U.S. Cl. CPC F26B 13/14; F26B 13/24; F26B 5/00

(57) ABSTRACT

A dryer for flexible transparent microplate strips used in genetic profiling and methods for drying flexible transparent microplate strips used in genetic profiling. The dryer includes vents for blowing compressed air on the strips and a reel-to-reel design for quickly moving the strips across the vents.

### FIELD OF THE INVENTION

The invention relates to a step in a genetic profiling technique employing flexible transparent microplate strips with arrays of wells, each containing genetic material to be profiled. More specifically, the invention relates to systems and methods for drying flexible transparent microplate strips after they have been submerged in liquid heating and cooling baths in one or more rounds of the polymerase chain reaction (PCR) and before genetic profiling.

### BACKGROUND

Flexible transparent microplate strips (“Strips”), such as the Array Tape™ sold by Douglas Scientific®, provide substrates for highly automated, low volume, fast, and efficient methods for genetically profiling a large number of genetic samples. Genetic profiling methods that use Strips involve sequential automated steps. First, each individual well in a Strip is loaded with genetic materials of interest and a solution of reagents, for example DNA polymerase, DNA bases, and fluorescently labeled SNP probes. The Strip is then covered with a pressure-activated adhesive that seals the materials in the individual wells and prevents leakage between wells or to the external environment. The flexibility of the Strips allows them to be wound around spools that can be more easily handled than unraveled Strips, which can be many feet long. After loading and sealing, spooled Strips are submerged in successive hot and cold baths in one or more rounds of the polymerase chain reaction (PCR) to amplify the genetic material. The resulting Strips must then be dried before they are loaded into an apparatus that probes the material in each well for genetic profiling. In prior art systems, the drying step created a bottleneck in this otherwise fast and efficient genetic profiling method. There thus exists a need in the art for a faster system and method for drying Strips.

### SUMMARY

The invention includes a drying apparatus for a flexible transparent microplate strip comprising a pair of opposing air vents formed by elongated or angled holes directed toward the strip and attached to a source of pressurized air, wherein the height of the vents is greater than or approximately equal to the height of the strip. The holes of the drying apparatus may be oriented substantially perpendicular to the length of the microplate strip. The flexible transparent microplate strip may be loaded onto the drying apparatus on a first spool. The flexible transparent microplate strip may be unwound from the first spool, fed between the vents, then wound onto a second spool.

The drying apparatus may include a source of compressed air and a pressure regulator. The drying apparatus may include a sensor to determine whether a cover is open and electronics that stop a drying operation and turn off air flow when the cover is open. The drying apparatus may include electronics that turn off air flow and stop spool winding when a drying operation is complete.

The invention includes a method of drying a flexible transparent microplate strip using the drying apparatus described above by pulling the strip between a pair of opposing elongated or angled holes directed toward the strip and attached to a source of pressurized air, wherein the height of the vents is greater than or approximately equal to the height of the strips.

### DESCRIPTIONS OF THE FIGURES

FIG. 1 shows an embodiment of an apparatus of the invention.

FIG. 2 shows a magnification of the region A of FIG. 1 providing a detailed view of the air blade portion of the FIG. 1 embodiment.

FIG. 3 shows a side view of the FIG. 1 embodiment.

### DETAILED DESCRIPTION OF THE PREFERRED EMBODIMENT

The invention provides a system and method for drying Strips used in genetic profiling. In the preferred embodiment, the invention includes a spool-to-spool rapid unwinding/winding apparatus, air vents, and an air pressure regulator. The invention provides the benefit of rapidly drying Strips, thus eliminating a bottleneck in common genetic profiling systems.

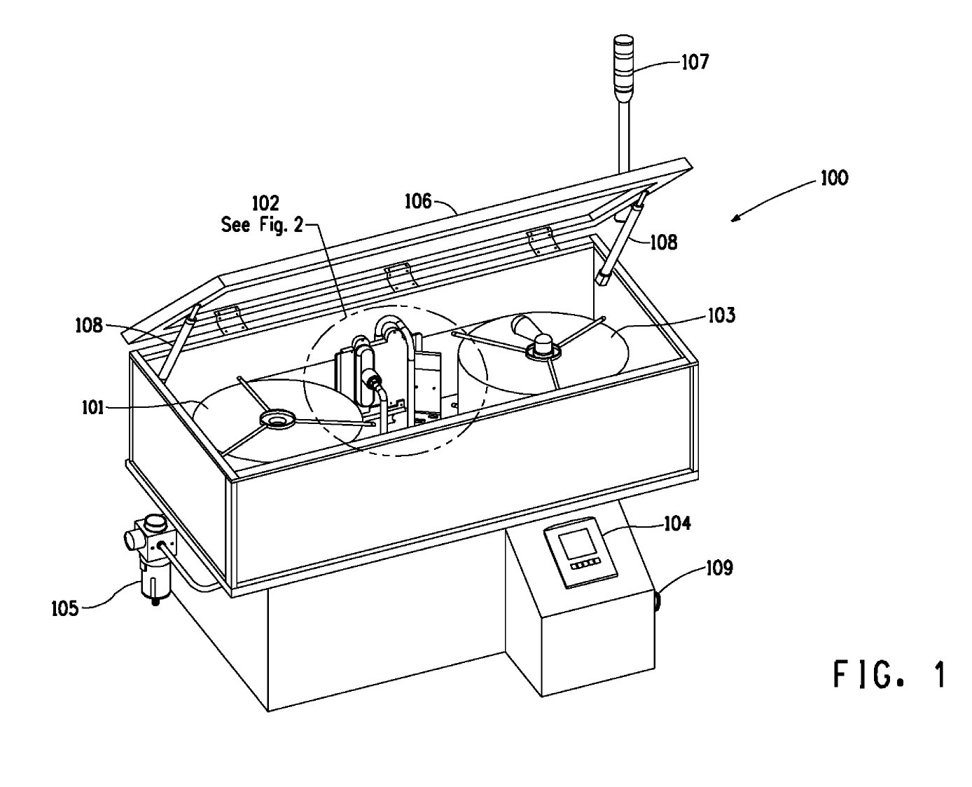

In the embodiment of the invention shown in FIG. 1, a spool 101 of a Strip is loaded onto a spindle. The free end of the Strip passes through a pair of air vents 102 and is fastened to a second spool 103 on a second spindle. The apparatus includes a user control panel 104 for controlling its operation. A regulator 105 allows control of the air pressure input to the dryer and additional electronic controls allow the operator additional pressure control to allow adjustment of the air speed of the air vents 102. The apparatus includes a top cover 106 that may be opened to allow loading the Strip and closed during operation to minimize noise and prevent external interference during the drying process. The walls and cover of the drying apparatus may be insulated to further reduce noise levels. Pneumatic strut lift supports 108 assist in opening the cover 106 and holding it open. An integrated sensor provides a shut-off signal to stop the drying operation when the cover is opened. An emergency cut-off switch 109 likewise allows a user to stop the drying operation. A light tower 107 provides users indications as to the status of the apparatus with various colors indicating the machine is idle with no errors, the machine is in operation with no errors, or that an error has occurred.

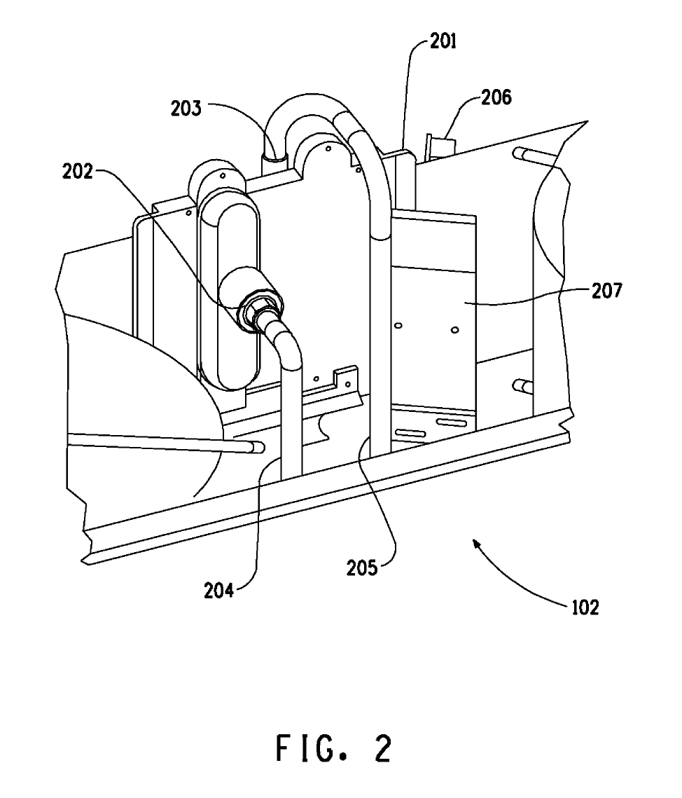

FIG. 2 shows a detail of the air vent apparatus of the embodiment shown in FIG. 1. Air vent support structure 201 is connected to air vent inlets 202 and 203 on either side of the support structure 201. Strips are run through the inside portion of the support structure 201. Lines 204 and 205 direct pressurized air to elongated air vents directed to the inside portion of the support structure 201 to form the high air speed air jets that effect the drying. The elongated air vents are designed to be at least about equal in height to the height of the Strips. Alternatively, the air vents may have a number of angled holes instead of a single elongated air vent to direct high speed air on the Strip. Sensor 206 emits light, which is reflected by reflector 207 to detect the presence of a Strip. Once the sensor 206 detects no strip due to completion of a drying operation, the dryer automatically shuts off and the light tower 107 alerts the operator that the drying cycle is complete.

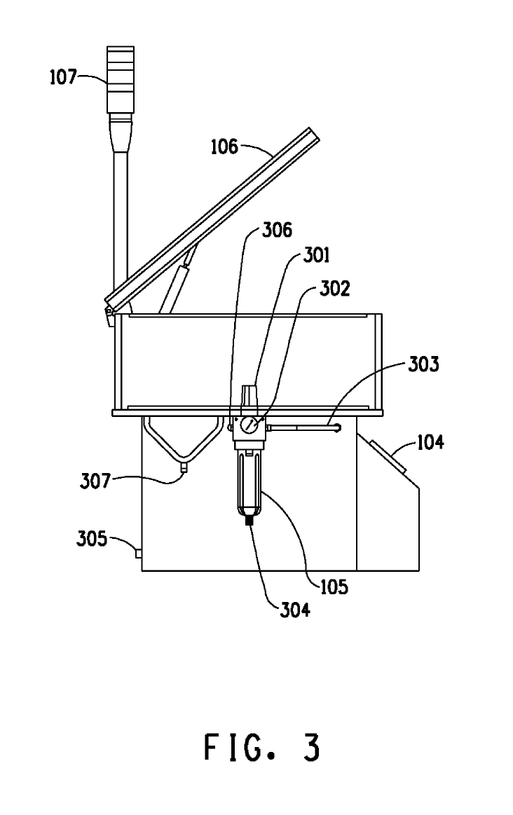

FIG. 3 shows a left side detail of the Strip dryer embodiment shown in FIG. 1. Pressure regulator 105 includes a pressure adjustment knob 301 and a pressure indicator dial 302. Air inlet 306 is connectable to a source of pressurized air. Air pressure set by pressure adjustment knob 301 and indicated by the pressure indicator dial 302 is directed to the two air blade inlets 202 and 203 by outlet line 303. The regulator also includes a filter and a drain 304. Drain connection 307 can be connected to a drain hose to remove the water that accumulates in the drying apparatus during the drying operation. The air regulator 105 ensures a uniform air pressure inlet to the dryer. Additional electronic controls and an internal air regulator (not shown) allow the operator to select a different air pressure than input at regulator 105 in order to control the air speed from the vents. The dryer includes a main power switch 305.

While the FIG. 1 embodiment has been described in detail to illustrate the invention by one example, it will be readily apparent by those of ordinary skill in the art that modifications may be practiced within the scope of the invention as limited only by the scope of the claims.

What is claimed is:

1. A drying apparatus for a flexible transparent microplate strip comprising a pair of opposing air vents formed by elongated or angled holes directed toward the strip and attached to a source of pressurized air, wherein the height of the vents is greater than or approximately equal to the height of the strip.

2. The drying apparatus of claim 1, wherein the holes are oriented substantially perpendicular to the length of the microplate strip.

3. The drying apparatus of claim 1, wherein the flexible transparent microplate strip is loaded onto the drying apparatus on a first spool.

4. The drying apparatus of claim 3, wherein the flexible transparent microplate strip is unwound from the first spool, fed between the vents, then wound onto a second spool.

5. The drying apparatus of claim 2, wherein a flexible transparent microplate strip is loaded onto the drying apparatus on a first spool.

6. The drying apparatus of claim 5, wherein the flexible transparent microplate strip is unwound from the first stool, fed between the vents, then wound onto a second spool.

7. The drying apparatus of claim 1, further comprising a source of compressed air and a pressure regulator.

8. The drying apparatus of claim 1, further comprising a sensor to determine whether a cover is open and electronics that stop a drying operation and turn off air flow when the cover is open.

9. The drying apparatus of claim 1, further comprising electronics that turn off air flow and stop spool winding when a drying operation is complete.

10. A method of drying a flexible transparent microplate strip comprising pulling the strip between a pair of opposing elongated or angled holes directed toward the strip and attached to a source of pressurized air, wherein the height of the vents is greater than or approximately equal to the height of the strips.

11. The method of claim 10, wherein the vents are oriented substantially perpendicular to the length of the microplate strip.

12. The method of claim 10, further comprising the step of loading the flexible transparent microplate strip onto the drying apparatus on a first spool.

13. The method of claim 12, further comprising the steps of unwinding the flexible transparent microplate strip from the first stool, feeding it between the elongated vents, then winding it onto a second spool.

14. The method of claim 11, further comprising the step of loading the flexible transparent microplate strip onto the drying apparatus on a first spool.

15. The method of claim 14, further comprising the steps of unwinding the flexible transparent microplate strip from the first stool, feeding it between the elongated vents, then winding it onto a second spool.

16. The method of claim 10, further comprising the steps of sensing a cover is open, stopping a drying operation, and turning off air flow.

17. The method of claim 10, further comprising turning off air flow and stopping spool winding when a drying operation is complete.
